(19) United States
(12) Patent Application Publication
(10) Pub. No.: US 2026/0131300 A1
(43) Pub. Date: May 14, 2026

(54) PROCESSING MATERIALS USING MICRO-PULSE MICRO-ARC PROCESSING

(71) Applicant: Joseph Brifman, Palm Coast, FL (US)

(72) Inventor: Joseph Brifman, Palm Coast, FL (US)

(21) Appl. No.: 19/425,210

(22) Filed: Dec. 18, 2025

Related U.S. Application Data
(63) Continuation-in-part of application No. 17/238,759, filed on Apr. 23, 2021, now abandoned.
(60) Provisional application No. 63/015,997, filed on Apr. 27, 2020.

(51) Int. Cl. B01J 19/08; B01J 19/18; C22B 4/00; C22B 59/00

(52) U.S. Cl. CPC B01J 19/087; B01J 19/1812; C22B 4/00; C22B 59/00; B01J 2219/085; B01J 2219/302; B01J 2219/30408; B01J 2219/30466; B01J 2219/30475

(57) ABSTRACT

A system for providing multi-level action on the flow of a multiphase product and method of use. The system comprises a tubular reactor through which waste material is passed. The tubular reactor comprises an inductor configured to produce a rotating magnetic field. A plurality of needle-shaped ferromagnetic elements are disposed within a cylindrical working zone of the reactor. The needle-shaped ferromagnetic elements oscillate reaching several thousand periods per second. The system and method for providing multi-level action on the flow of a multiphase product utilizes micro-pulse micro-arc processing of the material in the rotating magnetic fields to extract nutrients from organic matter and to refine rare earth elements from raw ore.

### CROSS-REFERENCE TO RELATED APPLICATION

The present application is a continuation in part application that claims priority to, and the benefit of, U.S. Non-provisional application Ser. No. 17/238,759, which was filed on Apr. 23, 2021, which claims priority to, and the benefit of, U.S. Provisional Application No. 63/015,997, which was filed on Apr. 27, 2020, all of which are incorporated herein by reference in their entirety.

### FIELD OF THE INVENTION

The present invention generally relates to a system and method for processing air, water, and solid waste, and more specifically to a system and method for refining peat and rare earth elements using a reactor that uses multiple short spark source discharges that are influenced by a rotating electromagnetic field. Accordingly, the present specification makes specific reference thereto. However, it is to be appreciated that aspects of the present invention are also equally amenable to other like applications, devices, and methods of manufacture.

### BACKGROUND OF THE INVENTION

By way of background, an ideal economy should self-sustaining and resilient. An ability to adjust to changes in population, economic growth, natural hazards and variability in production and demand requires a level of sophistication at all stages of production, processing, and waste management. A major limitation is the use and re-use of water and the optimization of all systems using best available technologies to approach the concept of zero waste.

Many technologies that are presented for dealing with environmental contaminants are either specific to the target, incremental improvements to existing technology, or need supplementary technology to deal with by-products created in the process or wasteful concentrates. The aim of a zero-waste system with zero discharges, accompanied by a lowered energy requirement, smaller footprint, and flexible design, as well as a fast start-up and shut-down to and from full operation, has been met in only a very few instances and even then only for a limited number of applications. Accordingly, industry and regulators are stuck with traditional technologies that have well known limitations. Small, incremental improvements over time or novel treatment technologies have added to the process trains but the goal of zero-discharges is missing.

In chemical treatment processes, impurities are removed as particles from the water as precipitates or colloids. These are accumulated in settling tanks prior to discharge in permitted areas or for delivery to shore based waste units. In some cases, they are adsorbed or accumulated onto other materials or targets such as in filtration or electrochemical systems. The shortcomings of existing systems using physical and chemical principles of purification include high construction and operating costs; the need for cleaning of units; complexity of the control and monitoring systems, large bulk and mass, and the need for specialized ventilation and additional safety measures for confined spaces. These are often combined with membrane or other types of filtration systems to remove residual solids or microorganisms. A further disadvantage of chemical treatment systems is that the treatment products prepared by these methods can contain residues of chemically active substances that are harmful to the aquatic and marine biosphere so that further treatments are required.

The biological treatment of wastewater uses bacteria that process impurities into a substance that can be removed by microbial conversion to energy or adsorbable species or gases amongst other forms. Biological treatment systems require creation and maintenance of optimal conditions for the existence and multiplication of bacteria, with considerable time required to put the plant into operation after prolonged interruptions to operation. While marine based biological systems with brackish or saltwater are now relatively common, they are sensitive to changes in feed water composition. Biochemical treatment units need to be continuously fed to avoid incomplete treatment or prolonged start up times. When the delivery of wastewater to the unit is reduced or stopped, the sludge biomass activity reduces with corresponding reductions in treatment efficacy sometimes for extended periods.

Widely used technologies and equipment for disposal of wastewater use multistage cleaning methods: reagent treatment, coagulation, aeration, sedimentation, filtration, neutralization of slimes, clarification and more. An important factor that degrades the technical and economic efficiency is the low process intensity in the operating zones due to relatively low concentrations of the active components. Processes are correspondingly slow so that the size of the equipment is large, with low material and energy efficiency.

A wastewater stream typically contains mixtures of various substances which are physically combined but may, or may not, be chemically combined in solid and liquid phases. These mixtures may differ in chemical and physical properties from the individual substances from which they originated. These solid-phase waste stream components may be settleable solids, suspended solids, or colloidal solids. The liquid-phase components may be colloids, soluble compounds, gases, or ions. Colloids are solids of such small size that they are dispersed with an adsorbed charge to maintain stasis in the liquid phase. These colloids are mixtures in which the particles are invisible to the naked eye, cannot be removed by filtration, but can be contained within a semi-permeable membrane. Solids may be encountered in liquids under several forms: slurries, solutions, colloidal dispersions, and solid suspensions.

Peat moss is a partially decomposed, carbon-based plant material that accumulates over thousands of years in in cold, marshy ecosystems. It is commonly used in gardening as a soil amendment because it is lightweight, retains a high amount of moisture, and is sterile. Due to its slow formation rate, it is not considered a renewable resource. Over thousands of years, this partially decomposed material builds up, forming a dark, fibrous substance called peat. The environmental impact of peat extraction itself is a major concern, as it can damage habitats and release carbon dioxide. The harvesting of peat moss also releases carbon dioxide into the air and even clears the way for methane release. Methane and CO2 are both greenhouse gasses known to contribute to global warming.

Organic substances are extracted from peat using various methods, including alkaline extraction with solutions like NaOH or KOH, acid hydrolysis with acids such as sulfuric or nitric acid, and supercritical fluid extraction. Other techniques include ultrasound-assisted extraction and methods involving autoclaving at high temperature and pressure. The specific method chosen depends on the target compounds and desired purity. Some methods, particularly destructive ones like certain acid hydrolysis or hot-liquid extractions, can alter the extracted compounds. Solvent extraction methods can leave residues in the final product.

Rare earth elements are a group of 17 chemically similar metals, the 15 lanthanides plus scandium and yttrium, which are crucial for modern technology. These elements are not truly rare but are dispersed and often difficult to extract, making them valuable. They are used in everything from electronics and electric vehicles to lasers and wind turbines, enabling products to be smaller, faster, and more efficient.

Separating and purifying rare earth elements is notoriously complex, especially when dealing with lanthanide pairs, elements with nearly identical size and chemical properties. Traditional separation methods, such as mixer-settlers, become cost-prohibitive and space-intensive beyond 20 stages, limiting their effectiveness. Rare earth element extraction methods typically involve hydrometallurgy, which uses acidic leaching and solvent extraction to separate elements from ores, or pyrometallurgy, which uses high-temperature processes like fused salt electrolysis. Traditional methods are energy-intensive and environmentally damaging, prompting research into more sustainable techniques like biohydrometallurgy, ion exchange, and using new proteins for more selective binding. These methods can generate large volumes of acidic wastewater, radioactive waste (from minerals like monazite), toxic and flammable solvents, and air pollutants from roasting. They are also highly energy-intensive and can produce toxic gases.

Accordingly, there is a great need for a technology that enables the conversion of organic and inorganic sludges, mine tailing accumulations, sewage from all sources, industrial waste, and construction waste, into raw materials for reuse with minimal processing. There is also a need for a zero discharge processing of domestic and industrial wastes with on-site or local re-use. Similarly, there is a need for a chemical treatment process that is not harmful to the aquatic and marine biosphere. There is also a need for a way to remove environmental contamination that is flexible, requires low energy, and has a small footprint. There is also a need for a way to extract organic substances from peat and to refine rare earth elements in an effective and environmentally friendly way.

In this manner, the improved system of the present invention accomplishes all of the forgoing objectives, thereby providing an easy solution for converting sludges, mine tailing accumulations, sewage from all sources, industrial waste including organic and non-organic hazardous waste, and construction waste, into raw materials for reuse with minimal processing. A primary feature of the present invention is a way to convert organic waste into a high quality organic fertilizer by removing chemical impurities. The present invention allows for non-organic waste to be converted into metal oxides or stable chemical components for use as construction materials. The present invention can generate new materials and provide new synthesis pathways such as conversion of nitrogen and carbon to urea. Next, the improved system of the present invention is capable of reprocessing most types of waste into major sources of key materials while minimizing wastes from many existing industries, thereby preventing new accumulations while conserving and recycling water resources. Finally, the improved system of the present invention is capable of extracting organic substances from peat and to refine rare earth elements in an effective and environmentally friendly way. Importantly, the system requires no major oxygen inputs as with biological processes and no biological inputs.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a system for processing waste material. The system generates micro arcs and power micro impulses to treat the waste material. The system comprises a tubular reactor and a plurality of ferromagnetic elements. The tubular reactor comprises a tubular chamber and an inductor. The tubular chamber comprises a shell and a cylindrical working area. The cylindrical zone is encapsulated by the shell. The shell is magnetically nonreactive with the inductor. The tubular chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular chamber. The plurality of ferromagnetic elements are needle-shaped and configured to kinetically interact with the waste material when triggered by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The subject matter disclosed and claimed herein, in one embodiment thereof, comprises a method for processing waste material using a system for processing waste material. The system generates micro arcs and power micro impulses to treat the waste material. The method begins by pretreating the waste material using a traditional waste material treatment process. Pretreating is necessary to reduce the size of the waste materials to approximately 2 mm or less so that complete processing may be accomplished with the system. Normal screening or pretreatment processes are typically employed to achieve this. Then the pretreated waste material is treated with the system for processing waste material.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the waste material when activated by the rotating magnetic field generated by the inductor. The activated plurality of ferromagnetic elements generate the micro arcs and power micro impulses that kinetically treats the waste material. Depending on the waste material to be treated, the plurality of ferromagnetic elements may be coated with a catalytic metal or an elastic polymer shell.

The method continues by separating the treated waste material into usable component materials. The method may further comprises retreating at least a portion of the treated waste material with the system for treating waste material. Once retreated, the retreated waste material is separated into usable component materials.

The subject matter disclosed and claimed herein, in another embodiment thereof as method for processing material using a system for processing a material configured to generate a rotating electromagnetic field. The material for processing may be peat moss. The method begins by mechanically reducing the material in size via a sieve or a screen. Next, the material is treated with the system for processing material using a rotating electromagnetic field using microarcs and power micro pulses at values of magnetic field induction in a working area of a tubular reactor. The treated material is then separated into usable products.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the peat moss when activated by the rotating magnetic field generated by the inductor. The activated plurality of ferromagnetic elements generate the micro arcs and power micro impulses that kinetically treats the peat moss.

The subject matter disclosed and claimed herein, in another embodiment thereof as method for processing material using a system for processing a material configured to generate a rotating electromagnetic field. The material for processing may be rare earth element ore. The method begins by mechanically reducing the material in size via a sieve or a screen. Next, the material is treated with the system for processing material using a rotating electromagnetic field using microarcs and power micro pulses at values of magnetic field induction in a working area of a tubular reactor. The treated material is then separated into usable products.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the rare earth element ore when activated by the rotating magnetic field generated by the inductor. The activated plurality of ferromagnetic elements generate the micro arcs and power micro impulses that kinetically treats the rare earth element ore.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of a system for processing waste material of the present invention in accordance with the disclosed architecture.

FIG. 2 illustrates a rear perspective view of the system for processing waste material of the present invention in accordance with the disclosed architecture.

FIG. 3 illustrates an image of an operating zone of the system for processing waste material of the present invention in accordance with the disclosed architecture.

FIG. 4 illustrates a side cutaway view of a tubular reactor of the system for processing waste material of the present invention in accordance with the disclosed architecture.

FIG. 5 illustrates an end cutaway view of the tubular reactor of the system for processing waste material of the present invention in accordance with the disclosed architecture.

FIG. 6 illustrates a schematic view of a three-phase two-pole loop double-layer with a short pitch stator winding scheme of the tubular reactor of the system for processing waste material of the present invention in accordance with the disclosed architecture.

FIG. 7 illustrates a chart illustrating a differential between results of using a rotating magnetic field of the system for processing waste material versus using a traditional mixer to process waste.

FIG. 8 illustrates a schematic view of a method of processing waste material of the present invention using the system for processing waste material in accordance with the disclosed architecture.

FIG. 9 illustrates a schematic view of the method of processing waste material of the present invention using the system for processing waste material in accordance with the disclosed architecture.

FIG. 10 illustrates a chart illustrating results of using the system for processing waste material for the wastewater treatment of fish processing enterprises of the present invention in accordance with the disclosed architecture.

FIG. 11 illustrates a schematic view of a method for extracting organic substances from peat using the system for processing waste material in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a system and method for using micro arc processing in a rotating magnetic field for high purification of urban domestic and industrial wastewater and sewage sludge with minimum energy consumption. It can also be the basis for the construction of sewage treatment systems of inhabited locality used local and centralized sewerage (sanatoriums, hospitals, schools, hotels, offices and shopping complexes), as well as treatment facilities of any type industrial enterprises, including food and light industry, processing of agricultural products, industrial livestock farms, poultry farms, etc.

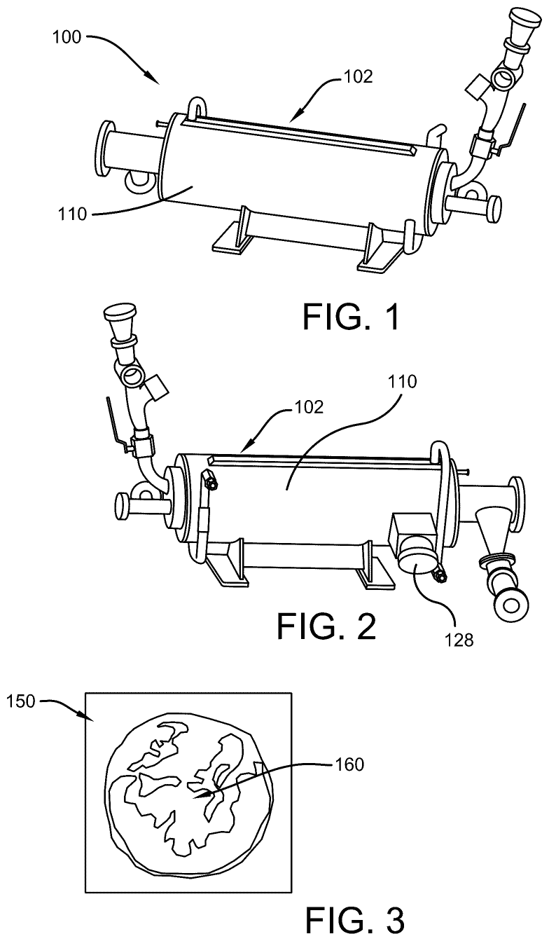

Referring initially to the drawings, FIGS. 1-6 illustrate a system 100 for processing waste material. The system 100 generates micro arcs and power micro impulses to treat the waste material. The system 100 comprises a tubular reactor 102 and a plurality of ferromagnetic elements 160. The system provides for the passage of material, such as gases, solids, or liquids, through the tubular reactor 102 in which an inductor generates a rotating electromagnetic field. The tubular reactor 102 comprises a housing 110 and a pair of flanges 112 positioned at opposing ends of the tubular reactor 110. The tubular reactor 102 is generally 30 to 50 cm in diameter and 400 to 1200 cm in length, although it can be smaller or larger in dimension as needed.

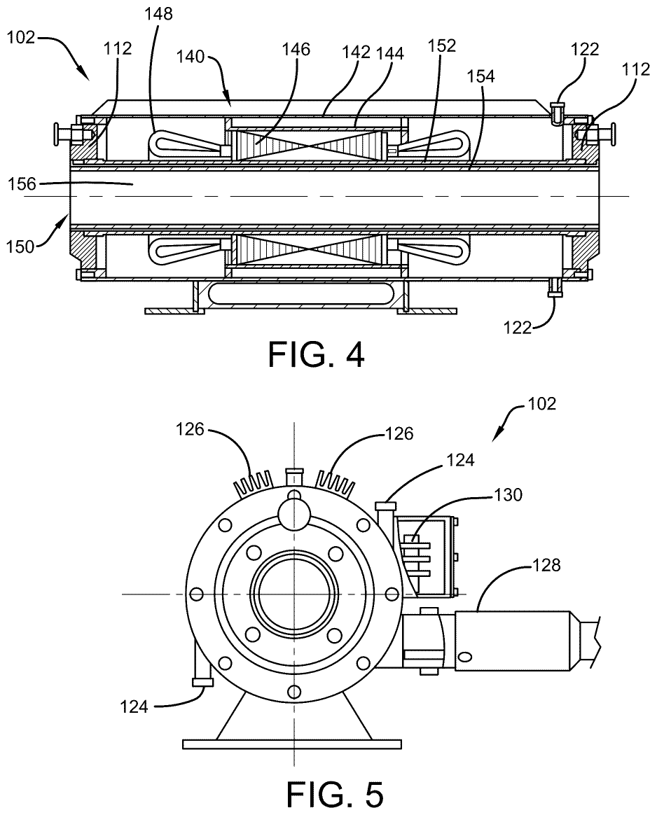

As illustrated in FIGS. 4 and 5, the tubular reactor 102 comprises a tubular chamber 150 and an inductor 140. The tubular chamber 150 comprises a shell 154 and a cylindrical working area 156. The cylindrical working area 156 is encapsulated by the shell 154. The shell 154 is magnetically nonreactive with the rotating electromagnetic field produced by the inductor 140. The shell 154 may be constructed from stainless non-magnetic steel AISI 321 or a basalt fiber. The tubular chamber 150 may further comprise a jacket 152. The jacket 152 may be an insulated sleeve or cooling jacket that lines the shell 154. The cooling jacket 152 is constructed to allow for the processing of waste substances at high temperatures up to at least 600 degrees Celsius.

The tubular reactor 102 further comprises control and thermal protection units, a frequency regulator of the supplied current from approximately 50 to 100 Hz, a power regulator installed in front of the inductor 140 in the range from approximately 5 to 100 kW with a continuous mode of its change, and a contactless phase switch with a switching frequency of approximately 50 to 100 periods per second. The tubular reactor 102 further comprises a power source 128 and a power regulator 130. The power regulator 130 is in electrical communication with the inductor 140. The tubular reactor 102 further comprises a reactor cooling component. The reactor cooling component is configured to cool the inductor 140. The reactor cooling component comprises a plurality of inlet pipes 122, a plurality of outlet pipes 124, and a plurality of fins 126 for containing a water-based or oil-based coolant. The tubular reactor can operate at a range of approximately five to 100 Kilowatts or higher.

The inductor 140 comprises a body 142, a magnetic core cassette 144, a magnetic circuit 146 and a winding 148. A core of the transformer of the inductor 140 may be laminated from electrical steel. The winding 148 is configured to generate the rotating electromagnetic field within the tubular working chamber 150 uniformly distributed and perpendicular to its axis. The winding 148 may be a symmetrical reduced two-layer loop, wire with oil-resistant insulation and operating temperature up to approximately to 200 degrees Celsius. Alternatively, the winding 148 may be constructed of wire with waterproof insulation with an operating temperature of up to approximately 90 degrees Celsius.

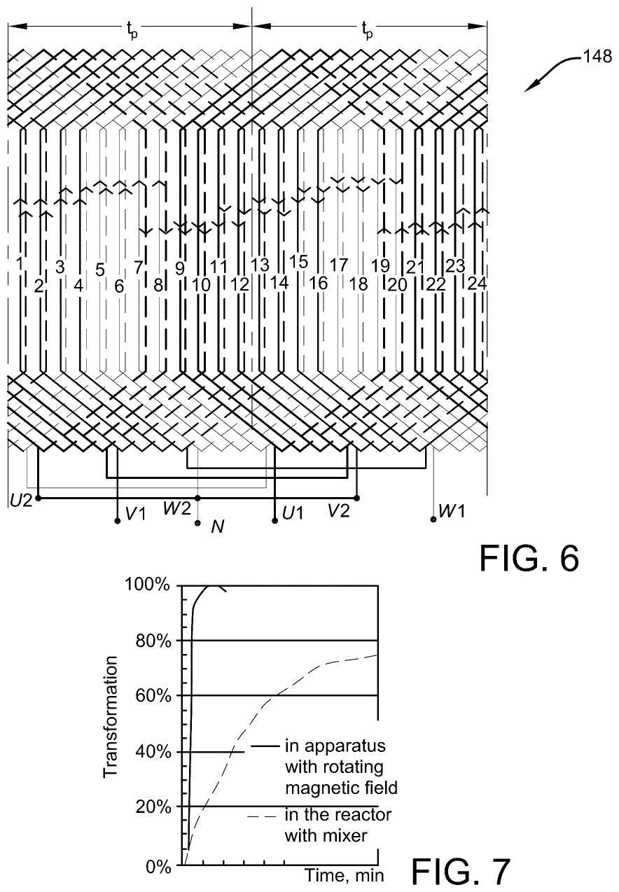

FIG. 6 illustrates a preferred winding scheme, where τp—indicates the pole pitch; V1, U1, W1—the beginning and V2, U2, W2—the ends of the phase windings, and N—neutral wire. The symmetrical two-layer loop reduced winding 148 ensures the symmetry of a three-phase inductor power supply system and improved magnetic field distribution in a stator core and the working chamber 156 equalizes magnetic field pulsations and electromagnetic system vibrations. A preferable range for the magnetic induction in the operating zone is from approximately 0.1 to 0.2 Tesla. The speed of rotation of the magnetic flux is preferably in the range from approximately 50 sec-1 to 100 sec-1, with the possibility of smooth adjustment. A core of the transformer of the inductor 140 may be constructed of extruded a composite ferromagnetic alloy.

The plurality of ferromagnetic elements 160 (hereinafter-“indenters”), are positional within the cylindrical working zone 156 of the non-magnetic tubular working chamber 150 that does not interact with the field. The plurality of ferromagnetic elements 160 are generally needle-shaped and configured to kinetically interact with the waste material when triggered by the rotating magnetic field generated by the inductor 140 as illustrated in FIG. 3. The activated plurality of ferromagnetic elements 160 generate the micro arcs and power micro impulses that kinetically treat the waste material.

As illustrated in FIG. 7, the processing results using a rotating magnetic field of the present invention and significantly better than those using a traditional mixer. Depending on the waste material to be treated, the plurality of ferromagnetic elements 160 may be coated with a can be coated with catalytic metals for certain processes (synthesis/distillation), or an elastic polymer shell to reduce contamination when processing substances with high purity requirements. The size of the ferromagnetic elements is most preferably in the range from 10 mm to 30 mm in length, and from 0.7 mm to 3 mm in diameter.

During their movement, the indenters continuously create micro arcs and power micro impulses, which in direct contact virtually no materials cannot withstand. The simultaneous influence of all these factors allows translating all processes in the working area 156 of the tubular reactor 102 into a kinetic mode, which in contrast to diffusion, inherent in all traditional processes, and, accordingly, dramatically increase the productivity of materials and media, increase the reaction rate, etc.

Under conditions of a strong electromagnetic field, powerful currents arise in the working bodies, leading to the formation of micro arcs when the micro circuits break during the rotational movement of the needles 160. Under the influence of the rotating magnetic field, the ferromagnetic elements 160 rotate with an accompanying change in polarity. With this magnetization reversal, there is a very rapid change in the discharge positions, entailing a rapid change in the linear size of the needles 160. As a result of these almost continuously emitted power impulses, a large force is applied to the environment (approximately 15 to 20 tons/mm2), acting over a small distance. In water, the extent or range of interaction of these pulses is several times larger than in solid-phase operations. When performing, the ferromagnetic elements 160 that fill the working chamber 156 gradually wear out, and the efficiency of the treatment process of necessary substances is reduced. Therefore, new indenters 160 are periodically supplied to the working chamber 156 by the dosing system 100, filling it with integral elements instead of the used ones. The indicator of filling of the working chamber 156 is the change of current of the phase winding 148 of the inductor 140, which is fixed by the devices and used by an automatic control system or operator.

When moving, the ferromagnetic working elements 160 continuously emit powerful local micro-impulses and micro-arcs (hereinafter “MIPMAP”). This action facilitates the intensive dispersion of any solid materials, as well as the mixing of the treated medium. Several effects are generated that combine with the local thermal and mechanical phenomena that occur when the ferromagnetic working elements 160 interact with a substance. The power of these effects is so great that, acting simultaneously on any particles of a substance, they provide structural and energy changes at the molecular and atomic level.

As a result of these interactions the wastewater to be treated is exposed to the following effects: particle dispersion; water ionization with separation of H+ and Hydroxyl Group OH—; weakening of intermolecular and interatomic bonds; oxidation/Reduction reactions (redox) by free radicals; magnetic field sustaining processes with highly ionized entities; magneto Hydrodynamic shocks comparable to cavitation processes or hydro-acoustic effects; intensive mixing; and localized thermal effects. The combined effect of all factors creates a very high level of activation of all components of the substance involved in the process. The reactions are no longer diffusion controlled but become a function of the discharge phenomena with associated increases in the rates of change or reaction kinetics. This process enables a rate increase in the treatment process by many orders of magnitude thereby reducing energy use and achieving processes previously considered unattainable.

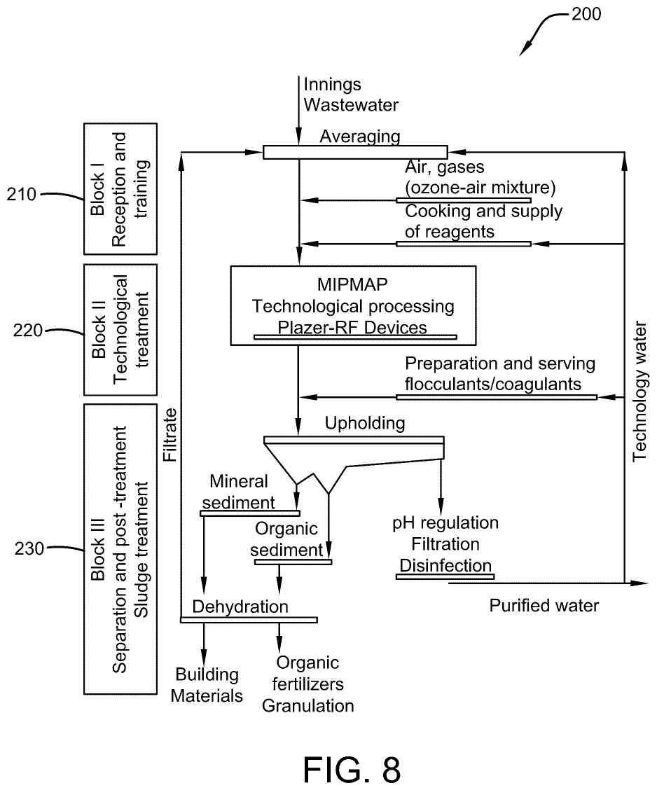

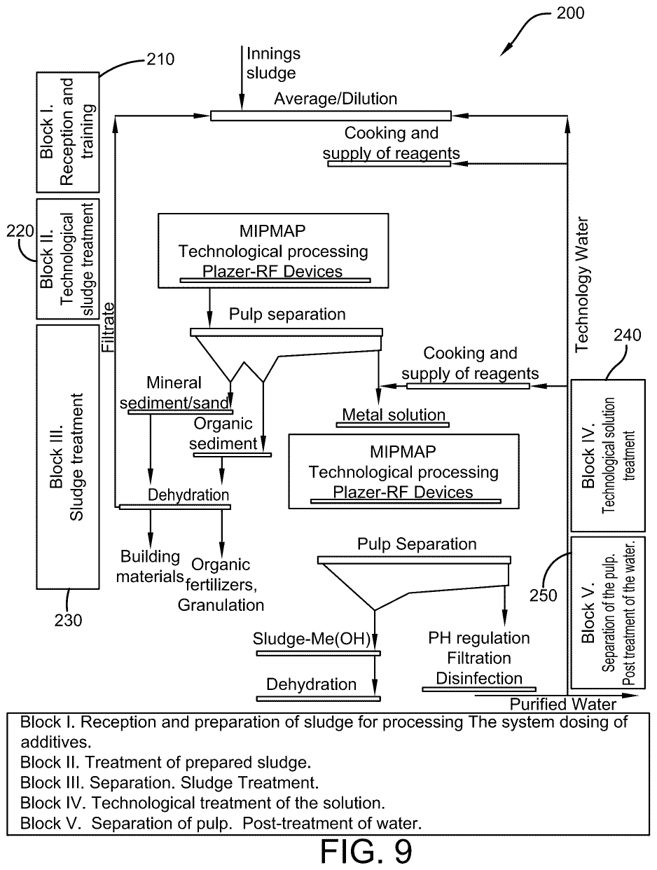

The subject matter disclosed and claimed herein, in another embodiment thereof as illustrated in FIGS. 8 and 9, comprises a method 200 for processing waste material using the system 100 for processing waste material. The system 100 generates micro arcs and power micro impulses to treat the waste material. The method 200 begins by pretreating the waste material using a traditional waste material treatment process at 210 which consists in the separation of magnetic components, separation of fat fractions, separation of solid particles and fragments for their further processing with a size of not more than 0.3-2.0 mm or their grinding to a size less than 0.3-2.0 mm. Then the pretreated waste material is treated with the system 100 for processing waste material comprising the tubular reactor 102 and the plurality of ferromagnetic elements 160 at 220 using a rotating electromagnetic field using microarcs and power micro pulses at values of magnetic field induction in the working area of the tubular reactor, which contains ferromagnetic needle elements, not less than 0.1-0.25 T.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the waste material when activated by the rotating magnetic field generated by the inductor 140. The ferromagnetic needle elements 160 may have a diameter of 0.5-1 mm and a length of 8-12 to intensify the mixing of liquid media, or liquid with gaseous media (including the formation of micro-(nanosized) bubbles), and also to increase the degree of solubility of miscible media (including gaseous media in liquids). Alternatively, the ferromagnetic needle elements 160 may have a diameter of 1-1.6 mm and a length of 12-20 mm to intensify the mixing of liquid media with solid particles with simultaneous dispersion (grinding) of these solid particles (including to obtain suspensions), as well as to intensify the mixing of liquid media, which are not prone to mixing and dissolving with each other, and to obtain emulsions. Alternatively, the ferromagnetic needle elements 160 may have a diameter of 1.6-3.2 mm and a length of 20-40 mm for intensification of dispersion (grinding) and mixing of solid materials, as well as for mixing (grinding) of liquid and semi-liquid materials (media) with increased values kinematic of viscosity greater than 0.155 in²/s (100 mm²/s). The ratio m/V of the mass of the ferromagnetic needle elements (m in grams) to the volume of the working area of the tubular reactor (V in cm³) may be selected from the range: m/V=0.1-0.4 g/cm³.

The activated plurality of ferromagnetic elements 160 generate the micro arcs and power micro impulses that kinetically treats the waste material. Depending on the waste material to be treated, the plurality of ferromagnetic elements 160 may be coated with a catalytic metal or an elastic polymer shell.

The method 200 continues at 230 by separating the treated waste material into usable component materials which comprises subsequent separation of the obtained fractions (products) after treatment of waste in a rotating electromagnetic field using microarcs and power micro pulses. The method 200 may further comprises retreating at least a portion of the treated waste material with the system 100 for treating waste material at 240. Once retreated, the retreated waste material is separated into usable component materials at 250.

The processes in the reactor can be enhanced by the addition of chemical additives comprising sources of hydrogen and hydroxide ions that can become reactive entities in the reaction zone such as the formation of superoxide and super hydrogen ions and other energized species. These reagents are not limited to hydrogen and hydroxide entities but can include other chemicals gases, liquids and solids that decompose or react to form energized entities in the reaction zone of the MIPMAP reactor.

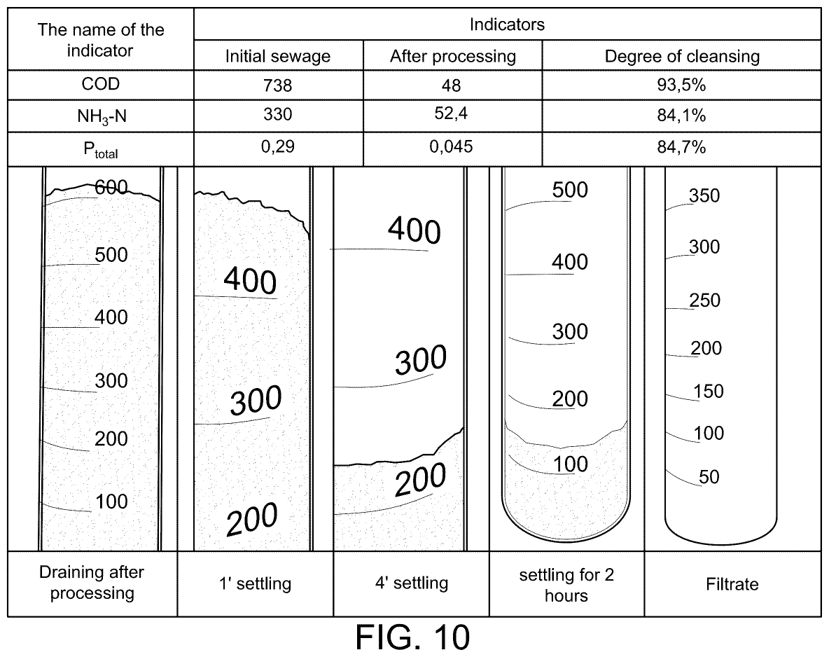

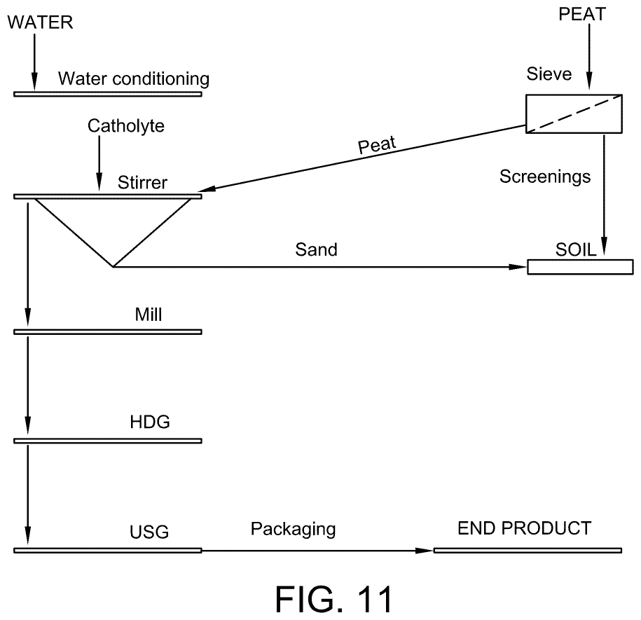

This unique combination of processes leads to accelerated chemical and physical interactions with rapid kinetics for the treatment processes. These are of both macro-duration and micro-duration. The outcomes from these complex reactions are that complex solids are formed with oxidation of heavy metals and removal of organic materials either through polymerization, breakdown, or adsorption. As illustrated in an example of a study on the wastewater treatment of fish processing enterprises shown in FIG. 10, the resultant water is free of living microbial organisms, trace organics, and heavy metals and suitable for most forms of re-use. The separated solid waste stream can be further treated for beneficial reuse or resource recovery, especially for nutrients. The solids removed are only that in the original wastewater with no added chemicals or biological by-products or sludges. The equipment of the present system provides a continuous flow through treatment of up to 10 m³/hr for each unit. Pretreatment requires grinding or settling to remove gross solids (solids to less than 2 mm and preferably around 500 microns) and post treatment with settling/filtration to remove solids.

The effect and advantages of micro arc processing in rotating magnetic fields using the system 100 and method 200 of the present invention is illustrated in several examples. The effect of micro arc processing in rotating magnetic fields on the content of poultry plants of microorganism organisms and cultures (as shown by the indicator organisms Escherichia coli and Staphylococcus aureus) in industrial wastes (litter) is provided in Table 1.

TABLE 1

| No. | Material | E-coli | St-aureus |
|---|---|---|---|
| 1 | Initial droppings of poultry | 10⁶ | 10⁶ |
| | farms (without processing) | | |
| 2 | The product after micro impulse | 0 | 0 |
| | microarc processing of droppings | | |
| | in rotating magnetic fields | | |

Determination of epidemic safety indicators of surface water for cattle manure is illustrated in Table 2.

TABLE 2

| | | Number of | Escherichia | |
|---|---|---|---|---|
| | | enterococci, | coli index, | Coli- |
| No. | Material | CFU in L | CFU in L | index |
| 1 | Initial cattle manure | 69 × 10³ | 15 × 10⁶ | 930 × 10⁶ |
| | (without processing) | | | |
| 2 | The product after | Is not | Is not | Is not |
| | micro impulse | detected | detected | detected |
| | microarc processing | | | |
| | (MIPMAP) | | | |

Effective wastewater treatment for galvanic production (Cr and Ni coating lines) using MIPMAP is illustrated in Table 3.

TABLE 3

| | Indicators, mg/l | | |
|---|---|---|---|
| Indicators | | | Degree of |
| name | Initial sewage | After processing | cleaning |
| COD | 264 | <0.2 | 99.9% |
| Cr total | 1.9 | 0.248 | 87.0% |
| Fe total | 440 | 0.07 | 99.9% |
| Ni | 16.3 | 0.5 | 97.0% |
| Zn | 1140 | 1.5 | 99.86% |
| Suspended particles | 108 | <4 | 96.3% |
| Oil Products | 13.0 | 0.17 | 98.7% |

Example of sludge sites processing from septic tanks of city aeration plant using devices for microarc processing in rotating magnetic fields. The composition of the initial sludge after the municipal wastewater treatment plants and after processing using MIPMAP technology is illustrated in Tables 4-5.

TABLE 4

| Water | | Organic | | N, | | | | | | | | | | | |
|---|---|---|---|---|---|---|---|---|---|---|---|---|---|---|---|
| content | | matters | Sand | total | P, | K, | Metals, mg/kg | | | | | | | | |
| % | pH | % | % | % | % | % | Sb | Hq | Pb | Cd | Ni | Cr | Mn | Zn | Cu |
| 82.6 | 7.4 | 35.6 | 30 | 2 | 3.7 | 0.03 | 38.5 | 5.0 | 224 | 118 | 164 | 3,635 | 462 | 5,840 | 1,306 |

TABLE 5

| | | Elements, mg/kg | | | | | | | | |
|---|---|---|---|---|---|---|---|---|---|---|
| Products | Units | Sb | Hg | Pb | Cd | Ni | Cr | Mn | Zn | Cu |
| Sewage sludge | mg/kg | 38.5 | 5 | 224 | 118 | 164 | 3,635 | 462 | 5,840 | 1,306 |
| (initial sludge) | | | | | | | | | | |

Derived products from sewage sludge

| | | | | | | | | | | |
|---|---|---|---|---|---|---|---|---|---|---|
| Organic sediment | mg/kg | — | — | 0.06 | 0.004 | 0.03 | 0.1 | 0.2 | 0.08 | 0.6 |
| (organic | | | | | | | | | | |
| fertilizer) | | | | | | | | | | |
| Metallic | mg/kg | 120 | — | 2,900 | 330 | 4,400 | 5,100 | 7,600 | 3,400 | 3,100 |
| concentrate | | | | | | | | | | |
| (metal hydroxide | | | | | | | | | | |
| sediment) | | | | | | | | | | |
| Recycling water | mg/l | — | — | 0.05 | — | 0.25 | 0.01 | — | — | 0.40 |

The metal content in the solution at various durations of cementation by iron is illustrated in Table 6.

TABLE 6

| | Metal content in solution, mg/L | | | |
|---|---|---|---|---|
| Metals | original solution | after 5 sec | after 10 sec | after 60 sec |
| Pt | 10 | 3.700 | 0.013 | 0.0 |
| Pd | 10 | 0.043 | 0.000 | 0.0 |
| Ir | 10 | 0.350 | 0.024 | 0.0 |
| Rh | 10 | 1.820 | 1.820 | 1.5 |

Exemplary areas of application of micro pulse micro arc processing in rotating magnetic fields (MIPMAP) are illustrated in Table 7 (NQ—indicates a positive increase but not quantified—process dependent)

TABLE 7

| | | Increase in specific indicators of | | | |
|---|---|---|---|---|---|
| | | traditional technologies (q-ty times) | | | |
| | Traditional | | Reduction | Reduced | |
| | technologies or | Productivity | of metal | power | Additional |
| Technology | equipment | growth | consumption | consumption | indicators |
| Mining | Methods of | NQ | NQ | NQ | Replace bulky |
| chemistry | hydrometallurgy | | | | vats and columns |
| | | | | | with compact |
| | | | | | plants and |
| | | | | | hydrocyclones |
| Extraction of | Acid dissolution, | 800-1,000 | NQ | NQ | A mobile line is |
| valuable | solvent extraction | | | | provided to the |
| components | electrochemistry | | | | development site |
| from ores with | | | | | |
| a low content of | | | | | |
| elements such | | | | | |
| as tungsten, | | | | | |
| gold, etc. | | | | | |
| Processing of | Traditional | NQ | NQ | NQ | The yield is 5 to |
| dumps for the | processing | | | | 10 times higher. |
| purpose of | systems | | | | Capital costs are |
| extracting | (hydrometallurgy) | | | | 20-100 times |
| valuable | | | | | lower. |
| impurities | | | | | |
| (gold, copper, | | | | | |
| nickel, etc.) | | | | | |
| Powder | Vibro- and ball | 100-200 | 15-20 | 100-120 | The grinding |
| metallurgy: | mills Mixers | 80-100 | 15-20 | 100-120 | speeds increase |
| a) grinding, | For iron | 2-3 | Comparable | 5-6 | sharply; the |
| obtaining | 1500 degrees C. | 100-120 | Comparable | 100-120 | powder is |
| nanopowders | in atmosphere H₂ | | | | activated. |
| [symbol] ) mixing | | | | | Very high |
| B) sintering | | | | | quality mixing |
| Γ) production | | | | | The sintering |
| of metal | | | | | temperature is |
| plastics | | | | | reduced by 100- |
| | | | | | 200° C. |
| | | | | | Sintering without |
| | | | | | protection at a |
| | | | | | temperature of |
| | | | | | 100-140° C. |
| Manufacture of | There are no | — | — | — | Sand is |
| waterproof | analogues | | | | processed with |
| sand for | | | | | additives at |
| waterproofing | | | | | normal |
| (hydrophobic | | | | | temperature and |
| materials) | | | | | pressure |
| Chemical | At high | NQ | NQ | NQ | The processes |
| industry | temperatures | | | | take place at low |
| a) | and pressures | | | | temperatures and |
| Homogeneous | using special | | | | pressures, which |
| processes | equipment | | | | makes it possible |
| b) | | | | | to simplify the |
| heterogeneous | | | | | equipment. The |
| processes | | | | | reaction rates are |
| | | | | | increased, this |
| | | | | | leads to a |
| | | | | | reduction in the |
| | | | | | range and size of |
| | | | | | the equipment. |
| Electronic | Vibro- and ball | NQ | NQ | NQ | Enhancing the |
| industry, | mills Mixers | | | | characteristics of |
| Activation, | | | | | electronic |
| grinding of | | | | | components and |
| ceramic | | | | | materials |
| materials for | | | | | |
| electronic | | | | | |
| components, | | | | | |
| boards, etc. | | | | | |
| Neutralization | Volumetric | 250 | 10 000 | Up to 10 | Reduction of |
| and utilization | accumulators of | | | | the content of |
| of bilge water | oil-containing | | | | petroleum |
| on ships and in | water | | | | products up to |
| ports. | | | | | MPC |
| Manufacture | Ball and roller | NQ | NQ | NQ | The quality of |
| of oil and | mills | | | | oil paints |
| facade paints | | | | | corresponds to |
| | | | | | the |
| | | | | | specification, |
| | | | | | facade-above. |
| Production of | Feed-processing | 5-10 | 5 000- | Comparable | Granules with low |
| mixed fodders | plants | | 10 000 | | production costs |
| from local raw | | | | | were obtained |
| materials | | | | | |
| Extraction of | Extraction takes | NQ | NQ | NQ | The extraction |
| essential oils, etc. | place at long | | | | takes place at |
| from field plants | exposures in alcohol | | | | room temperature |
| | and oils | | | | and the oils are not |
| | | | | | damaged |

Among the benefits and advantages of the innovative technology of the present invention is the possibility of complete sewage utilization to get commercial products, including purified water, organic fertilizers, purified fine sand, and metal concentrates. Biological treatment systems do not achieve complete cycle of sewage disposal, as there is a need of additional disposal of sludge, including its disinfection and dehydration. At the same time, there is a problem of cleaning heavy metals from the sludge which cannot be solved on site in most cases. A very important advantage of the innovative technology is the dispensing of the necessity for sludge beds. These can occupy tens and hundreds of acres in large biological treatment plants and can cause extensive damage to ecology. In addition, the equipment for microarc processing in rotating magnetic fields differs from conventional technology by using significantly lower materials intensity and lower power intensity for the purification process.

The subject matter disclosed and claimed herein, in another embodiment thereof as method for processing constructional material mixture using the system 100 for processing material. The system 100 generates micro arcs and power micro impulses to treat the constructional material mixture. The method begins by treating the constructional material mixture with the system for processing material using a rotating electromagnetic field using microarcs and power micro pulses at values of magnetic field induction in a working area of a tubular reactor. The system 100 comprises the tubular reactor 102 and the plurality of ferromagnetic elements 160 and uses a rotating electromagnetic field using microarcs and power micro pulses at values of magnetic field induction in the working area of the tubular reactor, which contains ferromagnetic needle elements, not less than 0.1-0.25 T. The constructional material mixture may comprise sand and cement, or other building components.

As discussed supra, the tubular reactor 102 comprises the tubular chamber 150 and the inductor 140. The tubular chamber 150 comprises the nonreactive shell 154 and the cylindrical working zone 156 encapsulated by the shell 154. The inductor 140 comprises the winding 148. The winding 148 is configured to generate the rotating electromagnetic field around the tubular working chamber 150. The plurality of ferromagnetic elements 160 are positional within the cylindrical working area 156 of the tubular working chamber 150. The plurality of ferromagnetic elements 160 are needle-shaped and configured to kinetically interact with the constructional material mixture when activated by the rotating magnetic field generated by the inductor 140. The ferromagnetic needle elements 160 may have a diameter of 0.5-3.2 mm and a length of 8-40 to intensify the mixing.

The activated plurality of ferromagnetic elements 160 generate the micro arcs and power micro impulses that kinetically treats the constructional material mixture. Depending on the constructional material mixture to be treated, the plurality of ferromagnetic elements 160 may be coated with a catalytic metal or an elastic polymer shell.

The method continues by separating the treated constructional material mixture into usable component materials which comprises subsequent separation of the obtained fractions (products) after treatment of the constructional material mixture in a rotating electromagnetic field using microarcs and power micro pulses. The method may further comprises retreating at least of portion of the treated constructional material mixture with the system for processing material. Once retreated, the retreated constructional material mixture is separated into usable component material.

Constructional mixtures in a required proportion are passed through a tubular reactor, where inductor generates a high-energy rotating electromagnetic field. Ferromagnetic elements of needle shape are put in the working cylindrical area of the reactor/inductor. These ferromagnetic working elements oscillate, reaching several thousand periods per second. Electric circuits are formed for a short time period, where strong currents arise, forming temporary circuits. When these chains or circuits break, a large number of electrical microarcs appear. When moving, ferromagnetic working elements continuously emit powerful local micro pulses and micro arcs. This action contributes the intensive mixing of the treated mixture, as well as the chipping of oxide films of any solid materials. The process destroys oxide films along fracture lines or along microcrack lines. A powerful local shock impulse which comes from the working elements affects the material or mixture being processed. As a result, the treated material acquires other beneficial properties.

Under the influence of a rotating magnetic field, the ferromagnetic elements rotate with a corresponding change in polarity. With such magnetization reversal, a very rapid change in geometric dimensions occurs along with the phenomenon of magnetostriction. As a result of these almost continuously emitted power pulses, a large, short distance force is applied to the environment (15-20 tons/mm2). As a result of these interactions, cement and other constructional mixtures are exposed to particle grinding; surface opening and removal of oxide and hydroxide films from the particle surface, sand and cement particles acquire electric charge; glued cement particles activity recovery, processes of interaction of the magnetic field with highly ionized objects; magnetostrictive shocks comparable to cavitation processes, and localized thermal effects.

There are several effects that are combined with local thermal and mechanical phenomena arising as a result of the interaction of ferromagnetic working elements with mixture. The power of these effects is so great that, acting simultaneously on any particle of mixture, they provide structural and energy changes at the molecular and atomic levels. The combined action of all factors creates a very high level of activation of all components of the substance that are involved in the process. Reactions are no longer controlled by diffusion, but become a function of discharge phenomena with a corresponding increase in the rate of change or reaction kinetics. This process makes it possible to increase many times the processing speed, thereby reducing energy consumption and achieving processes that were previously considered unattainable. This unique combination of processes results in accelerated chemical and physical interaction with fast kinetics of processing. Processes come in both macro durations and micro durations.

These complex interactions produce solid materials with other (new) chemical and physical properties. Experimentation has shown according to preliminary analyzes of prototypes, the treated mixture of sand and cement in the ratio of 15:5 and 2 parts of water, after the final solidification (after 28 days) showed the following results: non-treated prototypes before disruption had a compression of 400 psi with bending at 440 psi, and treated prototypes before disruption had a compression 2850 psi and a bending 1140 psi.

Due to the use of this technology, the performance indicators of compression and bending of constructional mixtures and concrete is significantly improved. This allows for the reduction in the amount of one of the most expensive components of constructional mixtures, which is cement, or increase the brand of constructional mixtures and concrete. All this leads to a reduction in the cost and weight of building structures while performing the same duty tasks. This also leads to a reduction of transportation costs and reduction of extracted raw resources.

The subject matter disclosed and claimed herein, in another embodiment thereof as method of processing material using a system for processing a material configured to generate a rotating electromagnetic field. The material may comprise peat moss or rare earth element ore. The system employs multilevel methods of action on a multicomponent and multiphase mixture of solid, liquid, and gas components of the processed product in the mechano-physicochemical processes of heat-mass-energy exchange of dispersion, emulsification, heat treatment, and the like.

There are many known methods of changing the physical and chemical properties of products by exposure to oscillatory processes of wave generators with various oscillatory devices, in which the wave energy leads to a change in the properties of the original product. Wave radiation can be from the solid surface of generators (piezoceramic and magnetostriction radiators), in liquid during cavitation, and in jet-edge generators. Next, sound energy, the source of ionization of the product molecules, is introduced into the liquid medium in the contact area of the reagents in the reaction chamber, and the sound transducers of the given frequencies and energies are located in the flow of the reactants. The disadvantage of this method is the need to use special generators and emitters, the transmission of high-intensity energy from which is limited. Next, the preparation of humic acids and humates from peat or brown coal can be carried out by cavitation dispersion of peat or brown coal in an aqueous solution of alkalis until the complete release of humic acids, followed by obtaining humates. The disadvantage of this method is the mandatory heating to high temperatures and the addition of alkalis, which neutralize humic and other acids. Next, devices use cavitation processes in a liquid, in which the resonance excitation of vortex flows interacting with each other in vortex tubes communicated with each other. The disadvantage of this method is the lack of preliminary energetic excitation of the extracting component, which necessitates the increase of the impact energy on the multiphase product to break hydrogen bonds and rapid wear of the generator parts. This disadvantage is inherent in most product conversion technologies.

The present invention provides a method for multi-level action on the flow of a multiphase product, in which: the extracting component is preliminarily activated in an electromagnetic field to break hydrogen bonds; the redox potential increases in order to intensify the course of physicochemical processes of heat and mass transfer in the treated medium; there is a guaranteed destruction of all microorganisms; there is a maximum extraction of organic and mineral substances into the water; the created intensity of wave energy is sufficient to achieve the destruction of the dispersed-aggregate state of the product and the necessary transformation of chemical bonds; acoustic cavitation is used in a vortex or jet stream, due to the energy of jet-edge generators; and the heat-mass-energy exchange process of the flow is used to carry out product transformations. The method allows for the ability to extract up to 94% of nutrients from any plants and other organic residues while fundamentally changing the concept of fertilizers, growth regulators, medical and cosmetic products, dietary supplements.

The task is solved by the method of multistage action on a multiphase product using the heat and mass-energy exchange process. The electromagnetic effect breaks the clusters, the effect of hydroxyl ions (OH—) disinfects the medium and shifts the redox potential to the “−1000” region. Cavitation treatment leads to heating and destruction of the dispersed-aggregate state of the initial product. Acoustic resonance excitation of one or more flows created in jet chambers or vortex tubes, the gas inlet into which is made in the form of jet-edge generators of a multiphase product, due to the high acoustic power of jet-edge generators, leads to intense acoustic cavitation of the liquid component of the product. Pulsating overpressure occurs in the gas and liquid phases of the product, leading to dispersion, emulsification, and other processes. Due to the large contacting area of the acoustic wave of the gas flow with the liquid and solid components of the processed product, the transfer of energy of high intensity is possible. The main problem of the transfer of high-intensity wave energy (10 W/cm2 and more) from the radiating surface to the liquid is the effect of the appearance of a “cavitation cloud” at the interface of the media, which prevents the transfer of energy. Therefore, a method of transferring high-intensity energy into a liquid and a dispersed solid product is needed, which is carried out in the proposed method using jet-edge generators.

For the implementation of the present method of processing a multiphase product, a number of devices are proposed that ensure the flow of the above processes. A Hartmann generator, consisting of one or more chambers in which the product processed in the streams is dispersed, emulsified, etc., due to the high-intensity wave energy of jet-edge generators. The flows can be either jet with a mixing chamber or vortex with vortex tubes. Between the liquid phase of the flow and the gas phase, especially during vortex motion, a large contact area is created, which increases in the process of interaction due to dispersion in the arising super pressures of the wave process of cavitation. The solid phase of the product is also subjected to dispersion and various transformations of the initial substance due to overpressures. So, for example, when processing a water-peat vortex flow activated by an output air or steam flow of a jet-edge generator with an ultrasound intensity of more than 20 W/cm², a valuable substance is obtained containing humic acids and other organic and mineral components available for plant nutrition.

The main task of developing a technological chain for processing a multiphase product is to achieve the optimal intensity of exposure to the product, sufficient for its breakdown and maximum yield of the required substance. To achieve such a result, the following devices are proposed: a hydrodynamic generator (HDG) and an ultrasonic generator (USG). The HDG carries out structuring, heating of water, grinding, and preliminary extraction of active substances from a suspension due to the breakdown of water clusters by a magnetic field and cavitation processes occurring in the resonance chambers of the HDG. There is practically no part wear, since cavitation bubbles appear in the volume of resonance chambers, and not on the surfaces of parts. In the USG, the optimal power of ultrasonic action on the working flow is carried out, which is achieved by strengthening the cavitation processes in the liquid by acoustic cavitation due to the energy of jet-edge ultrasonic generators.

The use of vortex working streams and the enhancement of cavitation processes due to the technology of many contiguous vortex streams makes it possible to achieve amplification and synchronization of ultrasonic vibrations and the wave process. The natural frequency of the device must correspond to the operating frequency at which the required product conversion is achieved. The achieved high intensity of ultrasonic radiation contributes to the achievement of a high cumulation of energy in the bubbles and cavitation ionization. The vortex flow created by a supersonic gas jet provides the possibility to increase the intensity of cavitation processes in the outer layers of the vortex due to a large centrifugal acceleration approximately equal to 1500 g, which leads to pressure increase in the flow and separation of bubbles to the center of the vortex with the formation of a gas column. To achieve the uniformity of the cavitation ionization process, cylindrical displacers are located in the centers of the working chambers with vortex tubes, enabling the ability to build zones of different intensities. Greater intensity is required in the area of product introduction, where the initial breakdown of the substance is achieved.

A destructor device may use acoustic resonant excitation of vortex flows of products for hydrocarbon breakdown. Jet-edge generators are used tuned to the specified frequencies in addition to the cavitation process. With the help of vortex and jet processes in the flow of a multiphase product, into which gas is introduced through gas-jet generators, it is possible to achieve a high intensity of acoustic treatment and obtain substances with new properties using the present invention.

The subject matter disclosed and claimed herein, in another embodiment thereof as method for processing material using a system for processing a material configured to generate a rotating electromagnetic field. The material for processing comprises peat moss, such as untreated harvested peat. The method begins by mechanically reducing the material in size via a sieve or a screen. Next, the material is treated with the system for processing material using a rotating electromagnetic field using microarcs and power micro pulses at values of magnetic field induction in a working area of a tubular reactor.

The system is configured to remove any organic residue from the peat moss. The system is further configured to apply a short distance force of between 15-20 tons/mm to the peat moss. The method may further comprise the step of retreating at least of portion of the treated peat moss with the system for processing peat moss. The treated material is then separated into usable products. The method may further comprise additional refining or purification steps involving a hydrodynamic generator (HDG), an ultrasonic generator (USG), and a jet-edge ultrasonic generator. The method then continues by using refined microelements from the removed organic residue as a super organic soil additive that may be tailored to a specific crop or planting application.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power. The tubular reactor may operate at a frequency of 50 to 100 Hertz, and a switching frequency of 50 to 100 periods per second.

The plurality of ferromagnetic elements are positional within the cylindrical working area of the tubular working chamber. The plurality of ferromagnetic elements are needle-shaped and configured to kinetically interact with the peat moss when activated by the rotating magnetic field generated by the inductor. Each of the plurality of needle-shaped ferromagnetic elements are typically less than 3 millimeters in diameter and less than 30 millimeters in length. The activated plurality of ferromagnetic elements generate the micro arcs and power micro impulses that kinetically treats the peat moss. The plurality of ferromagnetic elements may be coated with a catalytic metal or an elastic polymer shell.

The subject matter disclosed and claimed herein, in another embodiment thereof as method for processing material using a system for processing a material configured to generate a rotating electromagnetic field. The material for processing comprises rare earth element ore. The material for processing may also include traditional metal ores, mineral ores, zeolite, and any other mined elements and compounds. The method begins by mechanically reducing the material in size via a sieve or a screen. Next, the material is treated with the system for processing material using a rotating electromagnetic field using microarcs and power micro pulses at values of magnetic field induction in a working area of a tubular reactor. The treated rare earth element ore is then separated into refined rare earth elements. The system is configured to mill the rare earth element ore into a plurality of particles less than 100 microns in size in a single pass through the system. The system may further comprise the step of retreating at least of portion of the treated rare earth element ore with the system for separating and purifying rare earth elements.

The system comprises a tubular reactor and a plurality of ferromagnetic elements. The tubular reactor comprises a tubular chamber and an inductor. The tubular chamber comprises a shell and a cylindrical working area. The cylindrical working area is encapsulated by the shell. The shell is magnetically nonreactive with the inductor. The tubular working chamber may further comprise a jacket. The jacket is an insulated sleeve that lines the shell.

The inductor comprises a magnetic circuit and a winding. The winding is configured to generate a rotating electromagnetic field within the tubular chamber uniformly distributed and perpendicular to its axis. The winding may be a symmetrical reduced two-layer loop. The tubular reactor further comprises a power regulator. The power regulator is in electrical communication with the inductor. The tubular reactor further comprises a reactor cooling component. The reactor cooling component is configured to cool the inductor with water or oil. The tubular reactor is further configured to regulate the frequency of the supplied power.

The plurality of ferromagnetic elements are positional within the cylindrical working area of the tubular working chamber. The plurality of ferromagnetic elements are needle-shaped and configured to kinetically interact with the rare earth element ore when activated by the rotating magnetic field generated by the inductor. The activated plurality of ferromagnetic elements generate the micro arcs and power micro impulses that kinetically treats the rare earth element ore. The method may further comprise additional refining or purification steps involving a hydrodynamic generator (HDG), an ultrasonic generator (USG), and a jet-edge ultrasonic generator.

The subject matter disclosed and claimed herein, in another embodiment thereof as method for processing material using a system for processing a material configured to generate a rotating electromagnetic field. The material for processing comprises organic material, such as leaf waste or any other organic plant material. The system and method as previously described may be used to process the organic material in the tubular reactor and extract refined microelements for use as non-artificial soil additives. Similar to the process used for peat moss as described above, the inductor breaks down the organic waste separating out the useful micro elements and compounds, such as humic acid, folic acid, elemental sulfur, aluminum sulfate, ferrous sulfate, compounds with metal elements, micronutrients, and the like. The method then continues by using the refined microelements as a super organic soil additive that may be tailored to a specific crop or planting application.

Notwithstanding the forgoing, the system 100 can be any suitable size, shape, and configuration as is known in the art without affecting the overall concept of the invention, provided that it accomplishes the above stated objectives. One of ordinary skill in the art will appreciate that the shape and size of the system 100 and its various components, as show in the FIGS. are for illustrative purposes only, and that many other shapes and sizes of the system 100 are well within the scope of the present disclosure. Although dimensions of the system 100 and its components (i.e., length, width, and height) are important design parameters for good performance, the system 100 and its various components may be any shape or size that ensures optimal performance during use and/or that suits user need and/or preference. As such, the system 100 may be comprised of sizing/shaping that is appropriate and specific in regard to whatever the system 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of processing material using a system for processing a material configured to generate a rotating electromagnetic field, the method comprising:
mechanically reducing the material in size via a sieve or a screen;
treating the material with the system for processing material using a rotating electromagnetic field using microarcs and power micro pulses at values of magnetic field induction in a working area of a tubular reactor; and
separating the treated material into usable products.

2. The method of claim 1, wherein the material is peat moss.

3. The method of claim 1, wherein the material is rare earth elements ore.

4. The method of claim 1, wherein the system for processing material comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

5. The method of claim 4, wherein the tubular reactor operates at a frequency of 50 to 100 Hertz.

6. The method of claim 4, wherein the tubular reactor operates at a switching frequency of 50 to 100 periods per second.

7. The method of claim 4, wherein the winding is a symmetrical reduced two-layer loop.

8. The method of claim 4, wherein the plurality of ferromagnetic elements are needle-shaped.

9. The method of claim 4, wherein the plurality of ferromagnetic elements are coated with a catalytic metal or an elastic polymer shell.

10. A method of processing peat moss using a system for processing material configured to generate a rotating electromagnetic field, the method comprising:
treating the peat moss with the system for processing material using a rotating electromagnetic field using microarcs and power micro pulses at values of magnetic field induction in a working area of a tubular reactor.

11. The method of claim 10, wherein the system for processing peat moss comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

12. The method of claim 11, wherein the peat moss is untreated harvested peat moss.

13. The method of claim 12, wherein the system is configured to remove organic residue from the peat moss.

14. The method of claim 11, wherein the system is configured to apply a short distance force of between 15-20 tons/mm to the peat moss.

15. The method of claim 11, wherein each of the plurality of needle-shaped ferromagnetic elements are less than 3 millimeters in diameter and less than 30 millimeters in length.

16. The method of claim 11 further comprising the step of retreating at least of portion of the treated peat moss with the system for processing peat moss.

17. A method of separating and purifying rare earth elements from ore using a system for processing material configured to generate a rotating electromagnetic field, the method comprising:
treating a rare earth element ore with the system for processing material using a rotating electromagnetic field using microarcs and power micro pulses at values of magnetic field induction in a working area of a tubular reactor; and
separating the rare earth element from the treated rare earth element ore.

18. The method of claim 17, wherein the system for separating and purifying rare earth elements comprises:
a tubular reactor comprising:
a tubular chamber comprising a cylindrical working area encapsulated within a nonreactive shell; and
an inductor comprising a winding configured to generate a rotating electromagnetic field within the tubular chamber uniformly distributed within and perpendicular to its axis;
a reactor cooling component for cooling the inductor; and
a plurality of needle-shaped ferromagnetic elements positional within the working cylindrical area configured to interact with the rotating electromagnetic field.

19. The method of claim 18, wherein the system is configured to mill the rare earth element ore into a plurality of particles less than 100 microns in size in a single pass through the system.

20. The method of claim 18 further comprising the step of retreating at least of portion of the treated rare earth element ore with the system for separating and purifying rare earth elements.
